(19) United States
(12) Patent Application Publication
(10) Pub. No.: US 2007/0272127 A1
(43) Pub. Date: Nov. 29, 2007

(54) Marble mix kit and method of producing same

(76) Inventor: Antonio Puccio, Miller Place, NY (US)

Correspondence Address: Michael A. Petrocelli, 53 Roosevelt Ave., Sayville, NY, 11782, US

(21) Appl. No.: 11/442,623

(22) Filed: May 27, 2006

(51) Int. Cl. C04B 16/00; C04B 14/00

(52) U.S. Cl. 106/712; 106/738

(57) ABSTRACT

A marble dust mixture kit and method for providing the same. The marble dust mixture is for application to an inner surface of a cement pool. The marble dust mixture kit includes a marble mix composition of white cement, marble dust, and a specified amount of dye. The marble dust mixture kit is preferably contained in a sealable container.

### FIELD OF THE INVENTION

This invention relates to coatings on the outer surface of a cement pool, and more particularly to pre-packaged coating mixtures for use in a final coating layer applied to the cement pool.

### DESCRIPTION OF RELATED ART

Typically, one of the first steps in built-in swimming pool construction is excavation of the pool site. After completion of the excavation process, the first structural piece of the swimming pool is installed in the form of a steel reinforcing cage. The steel reinforcing cage is bent to form a gridlike pattern and is used to strengthen the pool's cement shell. At this point, all internal plumbing fittings are installed. The fittings may be designed to penetrate from the shell exterior to the pool's interior. The gridlike pattern is used to strengthen the pool's cement shell. The gunite application process includes a gunite rig, or pump truck. The pump truck pumps grout mix or shotcrete from a cement truck through a hose and out a nozzle. The nozzle is attached to an air compressor which causes the material to spray out of the nozzle.

Next, the marble dust finish or coating is applied to the surface of the gunite surface. The final surface of an in-ground cement pool should be the marble dust finish. The life of the marble dust finish, or dusted interior, is dependent on a number of factors including proper chemical balances, such as the amount of calcium.

Additionally, the marble dust coating can be used to affix tiles. A layer of marble dust coating is applied to the surface of the in-ground cement pool, then the tiles are affixed to the coating. A disadvantage of current methods of affixing tiles is that consistency of the mix can vary from batch to batch causing variation in the quality of the mix and it's capability to affix the tiles. If the mix is not optimum, over time, the mix will crack and the tiles will fall off. Also, if multiple mix batches are used to affix tiles, each batch of mix may not have a consistent color, and thus an undesirable difference in the color of the mix between the tiles will occur.

U.S. Pat. No. 5,660,620 to Flores-Garza issued on Aug. 26, 1997 discloses a mixture of Portland cement, marble dust, lime, and ground salt. The product is in a powdered state, which can be mixed with water. The Flores-Garza Waterproofing Composition discloses a mixture of Portland cement, marble dust, lime, and ground salt, which is premixed dry for the later addition of water.

U.S. Pat. No. 4,436,204 to Sowinski issued on Mar. 13, 1984 discloses a drywall joint compound and packaging. The drywall joint compound can be obtained as a dry powder for admixture with water before use, or sold in a ready-mix form, with water admixed at the joint compound manufacturing facility. The ready-mix slurry is sealed in a package using a plastic film container.

The Technical Bulletin by DAP®, revised publication date Feb. 3, 2003, discloses a ready-mixed concrete patch which includes a color, solid content, and Vinyl Acetate vehicle. It has the consistency of a paste which requires drying time. The material is packaged in various size containers, e.g., quart, and gallon.

Another, Technical Bulletin by DAP®, revised publication date Nov. 4, 2002, discloses a Quick Plug Hydraulic Cement. The dry mix comprises (section 2): hydrated lime; Portland cement; fused calcium aluminate; crystalline silica; and calcium sulfate. The dry mix comes in different size boxes or a 10 lb pail. The Quick Plug Hydraulic Cement is mixed with water to create a putty-like paste.

The DAP quick plug hydraulic cement datasheet discloses a premix of hydrated lime, Portland cement, fused calcium aluminate, crystalline silica, and calcium sulfate. The premix is packaged in various sizes including a 2.5 lb box, 5 lb box, and 10 lb pail.

The datasheet by LaHabra, copyright date August 2004, discloses a premixed colored stucco finish coat that requires the addition of water for use. The composition of the premix is Portland cement, hydrated lime, aggregates, and proprietary ingredients. The product is available in two-pound boxes, packed 24 per case.

U.S. Pat. No. 3,853,570 to Nonis et al. discloses a cement composition for use in producing a “marbly” appearance which includes Portland cement, marble dust, and dolomite aggregate.

U.S. Pat. No. 2,758,033 to H. P. Burney, Jr., et al. issued on Aug. 7, 1956 discloses a mix of Portland cement and limestone, which is then mixed with water to provide a cementitious product having qualities of natural limestone.

U.S. Pat. No. 6,344,081 to Pelot et al. issued on Feb. 5, 2002 discloses concrete compositions which contain glass particles, and in another embodiment glass particles and fly ash.

U.S. Pat. No. 5,908,502 to Cangiano et al. issued on Jun. 1, 1999 discloses limestone filled Portland cement.

U.S. Pat. No. 3,366,720 to K. Burger issues on Jan. 30, 1968 discloses a mixture of hard rock particles, one part hydraulic cement and calcium chloride.

Problems in the field of pool construction occur when mixing and applying the marble dust finish or coating. One problem is the variation of consistency of the ingredients of the marble dust coating. Lack of consistency in the amounts of ingredients in the mixture may result in a poor marble dust finish on the pool surface. This can lead to undesirable results including cracking, peeling and discoloration, as well as, significant shortening of the life span of the coating.

Another problem when relying on a worker in the field is variation of the color of the marble dust coating. Even slight variations of the addition of a dye to the marble dust can undesirably vary the color of the final marble dust finish or coating. The coloring of the marble dust finish can undesirably vary from the customers selection and/or vary from a previous mixing, and/or a previous application when variations in the amount of dye occur.

Typically, the coloring as well as the rest of the individual ingredients are added at the construction site by a worker. The consistency of the mix as well as the color is entirely dependent on the skill of the worker adding quantities of the ingredients and mixing the ingredient to arrive at the marble dust finish or coating mix. Specifically, typically the construction worker will bring the ingredients to the pool area by carrying bags of Portland cement, which can be in excess of one hundred pounds, and marble dust bags. The worker mixes a measured amount of Portland cement and marble dust by hand and adds water. Thus, the typical method of creating marble dust mixture in the industry relies on the skill of the worker or supervisor at the site to mix the proper ingredients and the proper amounts of the ingredients.

Currently, a measured amount of dye is also added to the marble mix to create the desired color. The skill of the worker or supervisor is again relied on to measure and mix the dye into the marble dust mixture to produce the desired color. The color may be the specified color of the homeowner or a color to match an existing marble dust layer already on the pool.

Disadvantages of the present method of creating and mixing the marble dust mix include the mix being subject to the discretion of the worker or supervisor to include the right ingredients in the marble dust, and to mix it properly. Further, the dye must be mixed in the correct or specified quantity to result in the selected color or match a color of the marble mix already applied to the pool. The individual discretion and possible variation in mixing the ingredients can result in disadvantages in the final marble finish or coating. The disadvantages include, undesirable consistency of the marble dust mix, which, when applied to the inner pool surface may lead to cracking of the marble dust finish, undesirable wear and tear, and undesirable fading of the color of the marble dust finish. Further, if the dye is not mixed in the proper amounts, the color is not as specified or does not match the color of marble dust coating already applied.

None of the above references provide solutions to problems in the art including providing a premixed combination of marble dust elements for use in the final coating of a cement pool which addresses the problems detailed above. Therefore, a need exists for a means for application of a marble dust coating to a pool surface which addresses the shortcomings discussed.

### SUMMARY OF THE INVENTION

According to an aspect of the present invention a cement mixture kit is provides a marble dust mix for application to an inner surface of a cement pool. The cement mixture kit includes, white cement, marble dust, and a specified amount of dye preferably in a sealable container. The white cement, marble dust, and dye are mixed together in the sealable container.

In a related aspect of the present invention the white cement is less than 50 percent of the marble dust mix, and the marble dust is more than 50 percent of the marble dust mix.

In a related aspect of the present invention the white cement, the marble dust, and the dye in the sealable container weigh about 73.15 pounds.

In a related aspect of the present invention the white cement is about 23.15 pounds, and the marble dust is about 50 pounds.

In a related aspect of the present invention the white cement weighs between about 15 pound to 25 pounds, and the marble dust weighs between about 45 pounds to 55 pounds.

In a related aspect of the present invention, the marble dust mix comprises a specified amount of calcium.

In a related aspect of the present invention, the sealable container is a bag.

In a further aspect of the present invention a method of preparing a cement mixture for applying to an inner surface of a pool comprises providing white cement, marble dust, and a specified amount of dye. Then, mixing the white cement, the marble dust, and the specified amount of dye, and containing the white cement, the marble dust, and the specified amount of dye in a sealable container.

In a related aspect of the present invention, the method further includes the step of mixing the white cement, the marble dust, and the specified amount of dye.

In a related aspect of the present invention, the method further includes the step of applying the marble dust mixture to the inner surface of the pool.

In a related aspect of the present invention, the method further includes the step of affixing at least one tile to the marble dust mixture.

In a related aspect of the present invention, the method further includes a step of providing a specified amount of calcium, and mixing the specified amount of calcium with the white cement, the marble dust, and the specified amount of dye.

In a related aspect of the present invention, the method further includes a step of providing a specified amount of calcium, and mixing the specified amount of calcium with the white cement, the marble dust, and the specified amount of dye, after a step of opening the sealable container.

In a related aspect of the present invention, the method further includes the steps of opening the sealable container at a pool construction site, mixing the marble dust mixture with water, and applying the marble dust mixture to the inner surface of the pool.

### DETAILED DESCRIPTION OF THE PREFERRED EMBODIMENT(S)

According to the invention, white cement, marble dust, and dye are mixed together and packaged to provide a premixed marble dust mix or marble mix. The marble mix is pre-mixed and in a container. The container is preferably sealable. A sealable container may include plastic bags or containers, paper bags, or other types of containers functionally equivalent and usable for containing the marble mix.

The marble mix according to the present invention preferably comprises white cement, marble dust, and dye. The premixed marble mix kit container preferably weighs about 73.15 lbs. The preferred ratio of white cement to marble dust is about: white cement 23.15 lbs; and marble dust 50 lbs. According to the present invention, the dye is preferably pre-mixed with the white cement and marble dust to create a specified color including, for example: white, silver, light gray, medium gray, and dark gray.

It is also envisioned in another embodiment of the invention that a specified amount of calcium may be added to the marble mix kit. Thus, the packaged marble mix kit would contain a specified amount of calcium, and may weigh slightly more than 73.15 pounds. In this embodiment, additional calcium could also be added, if needed, at the work site after opening the marble mix kit package.

The marble mix is preferably packaged in a container which is preferably sealable and waterproof. The premixed marble mix kit in a container weighs about 73.15 lbs. One advantage of a marble mix container weighing about 73.15 lbs is that the container is lighter and more easily carried than current bags of material which are mixed on site.

None of the references discussed in the background of the invention disclose the combination of elements, pre-mixed, and packaged as described in the present invention. Thus, none of the references disclose the combination of elements of the present invention in a kit or similarly packaged together. Further, none of the references disclosed herein include the combination of elements for use on the surface layer of an in-ground cement pool. Moreover, none of the references disclosed in the background of the invention disclose a method of providing the combination of elements and the composition the composition of those elements to provide the marble mix in a sealable container according to the present invention. Additionally, the present invention includes using the marble mix kit to process or prepare the marble dust finish for application to the pool surface, thereby facilitating the application of the marble dust finish to the final surface of the pool.

Additionally, a layer of marble dust coating can be applied to the surface of the in-ground cement pool, then tiles may be affixed to the coating. The marble mix coating according to the present invention provides a consistent mix of high integrity. The tiles therefore adhere to the quality marble mix and the color between the tiles is consistently the desired color.

In use, a worker typically must hand carry the containers of marble mix to the pool area. The lighter weight of the marble mix kit than current bags of ingredients greatly facilitates the speed of the worker, and alleviates the strain of lifting heavier bags of ingredients on the worker. Four bags of marble mix are about equal to a typical size mix currently used, which typically includes one bag of white cement and two bags of Georgia marble. The standardized container weight of the marble mix kit according to the present invention is light enough for most workers to carry and move into position.

At the pool area, water is added to the marble mix. Calcium is mixed with the marble mix at the construction site according to the atmospheric conditions and temperature at the time of use. An advantage of the marble mix kit is that it provides a standardized mix of white cement and marble dust. The marble mix ensures that a specified mixture of white cement and marble dust is provided at the work site, thus providing a consistent marble mix for application to the pool. The marble mix kit of the present invention also provides standardized colors by added a pre-measured amount of dye to each marble mix container. The standardization of color and consistency of the marble mix also is an advantage when applying tiles to the coating.

The method of the present invention provides mixing white cement, marble dust, and a specified amount of dye to provide the marble mix. The next step comprises containing the marble mix in, preferably, a sealable container, and having a composition of about 23.15 pounds of white cement and about 50 pounds of marble mix.

Additionally, the marble mix kit according to the present invention will save workers' time at the construction site by eliminating the time required to mix the ingredients on site. Mixing the ingredients on site includes time to measure, and mix, and the process of measuring the ingredients is subject to the skill of the worker. Therefore, an advantage of the marble mix method of the present invention is providing a premixed marble mix resulting in time savings of the worker and thereby monetary saving.

It will occur to those of ordinary skill that various modifications may be made to the disclosed embodiments. The disclosed embodiments are given by way of illustration and not limitation. The scope of the invention is intended to be defined by the appended claims.

What is claimed is:

1. A cement mixture kit providing a marble dust mix for application to an inner surface of a cement pool, which comprises:
white cement, marble dust, and a specified amount of dye;
a sealable container; and
the white cement, marble dust, and dye mixed together in the sealable container.

2. The kit of claim 1 wherein the white cement is less than 50 percent of the marble dust mix, and the marble dust is more than 50 percent of the marble dust mix.

3. The kit of claim 1 wherein the white cement, the marble dust, and the dye in the sealable container weigh about 73.15 pounds.

4. The kit of claim 1 wherein the white cement is about 23.15 pounds, and the marble dust is about 50 pounds.

5. The kit of claim 1 wherein the white cement weighs between about 15 pound to 25 pounds, and the marble dust weighs between about 45 pounds to 55 pounds.

6. The kit of claim 1 further comprising a specified amount of calcium.

7. The kit of claim 1 wherein the sealable container is a bag.

8. A method of preparing a marble dust mixture for applying to an inner surface of a pool, comprising:
providing white cement, marble dust, and a specified amount of dye;
mixing the white cement, the marble dust, and the specified amount of dye;
packaging the white cement, the marble dust, and the specified amount of dye in a sealable container.

9. The method of claim 8 wherein the white cement is about 23.15 pounds, and the marble dust is about 50 pounds.

10. The method of claim 8 further including a step of mixing the white cement, the marble dust, and the specified amount of dye.

11. The method of claim 10 further including a step of applying the marble dust mixture to the inner surface of the pool.

12. The method of claim 11 further including a step of affixing at least one tile to the marble dust mixture.

13. The method of claim 8 further including a step of providing a specified amount of calcium, and mixing the specified amount of calcium with the white cement, the marble dust, and the specified amount of dye.

14. The method of claim 8 further including a step of providing a specified amount of calcium, and mixing the specified amount of calcium with the white cement, the marble dust, and the specified amount of dye, after a step of opening the sealable container.

15. The method of claim 8 further including steps of opening the sealable container at a pool construction site, mixing the marble dust mixture with water, and applying the marble dust mixture to the inner surface of the pool.
